(19) United States
(12) Patent Application Publication
(10) Pub. No.: US 2020/0087478 A1
(43) Pub. Date: Mar. 19, 2020

(54) LOW EMISSION POLYPROPYLENE FOAM SHEETS

(71) Applicant: Borealis AG, Vienna (AT)

(72) Inventors: Hermann Braun, Linz (AT); Norbert Reichelt, Neuhofen/Krems (AT); Andreas Fuchs, Leonding (AT); Alexander Standler, Wartberg/Aist (AT); Paul De Mink, (US); Markus Gahleitner, Neuhofen/Krems (AT)

(21) Appl. No.: 16/467,202

(22) PCT Filed: Dec. 28, 2017
(86) PCT No.: PCT/EP2017/084693

§ 371 Date: Jun. 6, 2019

(30) Foreign Application Priority Data
Dec. 30, 2016 (EP) 16207541.0

(51) Int. Cl. C08J 9/14; C08J 9/16; C08J 9/22; C08J 7/18; C08J 5/18; C08F 110/06; C08K 5/00; C08K 5/14

(52) U.S. Cl. CPC C08J 9/141; C08F 2420/00; C08J 9/22; C08J 7/18; C08J 5/18; C08F 110/06; C08K 5/005; C08K 5/14; C08J 2201/03; C08J 2201/034; C08J 2203/14; C08J 2205/00; C08J 2207/00; C08J 2300/12; C08J 2323/12; C08J 2323/14; C08J 2323/08; C08J 9/16

(57) ABSTRACT

The invention relates to a process for the production of a foam having low organic compounds emissions, to polypropylene foamed products obtainable by the process, and to a process for the manufacture of low organic compounds emission articles comprising a foam for use in cars and food packaging. The process comprises the steps of: a) providing a foam comprising a propylene composition comprising a high melt strength propylene (HMS-PP) homopolymer or copolymer or combinations thereof, said HMS-PP foam having a melt strength of at least 25 cN at a maximum speed of at least 200 mm/s and a melting temperature of at least 135° C. and b) subjecting the HMS-PP foam to a thermal treatment at a temperature Tt which is preferably between 5 and 15° C. below the melting temperature Tm of the HMS-PP for a duration between preferably 1 and 10 minutes.

### FIELD OF THE INVENTION

The invention relates to a process for production of a foam having low organic compounds emissions, to foamed products obtainable by the process and to a process for the manufacture of low organic emission articles comprising a foam for use in applications where organic compounds emissions present a health hazard, in particular for use in closed rooms and compartments, in particular cars and for use in food packaging.

### BACKGROUND OF THE INVENTION

Foamed articles are widely used in car industry and as food packaging materials in particular because of the light weight, low cost and ease of shaping. The problem with foamed articles is that as a result of the foaming process the organic compound emissions will be higher for a foam than for the original polymer. The undesired emissions during use are exacerbated at elevated temperatures that can exist in car interiors.

Low organic compounds emissions implies low volatile organic compounds (VOC) and/or low FOG emissions as defined in standard VDA 278:2011. VDA regulations address the organic emissions from automotive components. The VDA test is based on Thermal Desorption Analysis of Organic Emissions for the Characterization of Non-Metallic Materials for Automobiles (10/2011) of the polypropylene polymer, wherein two classes of compounds are distinguished: highly and medium volatile substances (VOC) up to C25 and those of low volatility (FOG) in the range of C14 up to C32.

Little data exist on pollution levels within interior cabins of automobiles. Yet significant concerns and questions have been raised concerning the potential health hazards of the “new car smell” regarding carcinogenic and allergenic activity and respiratory problems.

Therefore foamed articles produced for the automotive interior industry are stocked for a long period of time, such that the VOCs have been emitted at least to some extent before being built into the vehicle's interior. This is a big disadvantage in the automotive industry in terms of timing, space and cost. Further this cannot significantly reduce the FOG because the ambient temperature vapour pressure of the FOG is too low, to date low-emitting, non-toxic interiors are not available.

Many attempts have been aimed at providing foams with reduced organic emissions. For example, U.S. Pat. No. 4,424,287 relates to thermoplastic foams of polystyrene which are prepared with a blowing agent which is a mixture of an organic plasticizing blowing agent, such as pentane, and an atmospheric gas, such as carbon dioxide. Such foams will have reduced emissions upon ageing as compared to those foamed with pure hydrocarbon blowing agent.

U.S. Pat. No. 6,245,823 relates to expanded polyethylene material by forming a foamable melt of polyethylene, a nucleating agent, a material which retards migration of alkanes, and a blowing agent which comprises 10 to 100 mole percent ethane. Low VOC emissions are claimed as one advantage.

U.S. Pat. No. 7,166,248 covers a process for producing an alkenyl aromatic polymer foam structure that comprises melting at least one alkenyl aromatic polymer resin. An effective amount of blowing agent mixture comprising at least one VOC blowing agent and acetone is dissolved in the at least one alkenyl aromatic polymer. The resulting foam structure is characterized by low emissions.

U.S. Pat. No. 6,521,675 describes a foamable polypropylene composition comprising a polypropylene resin having an D1238L melt flow rate of from about 0.5 to about 30 g/10 min, and a process for extruding rigid, foamed polypropylene sheet with improved surface appearance having a density in the range 0.4 to about 0.8 g/cm³. A chemical blowing agent is used and low emissions in general are claimed.

Foamed polypropylene has taken on an important role in the automotive industry for its versatility and recyclability, and is used for exterior automotive applications, such as bumpers and side sills, as well as interior automotive applications, such as dashboards and interior trim. However, the problem of existing polypropylene foams remains to reduce the volatile organic compounds. It is considered that during the extrusion foaming the VOC and FOG emissions are increased relative to the values of the starting polypropylene material because of the addition of blowing agent, which will partially dissolve in the polymer and be released slowly after foam formation, the increase of the specific surface facilitating the release of previously migration-limited components and to degradation phenomena in processing results in more oligomers.

### SUMMARY OF THE INVENTION

Accordingly, there is still a desire for a process for the manufacture of a foam with low VOC and FOG emissions.

According to the invention there has been provided a process for production of a foam having low organic compounds emissions, the process comprising the steps of:
a. providing a foam comprising a propylene composition comprising a high melt strength propylene (HMS-PP) homopolymer or copolymer or combinations thereof, said HMS-PP foam having a melt strength of at least 25 cN at a maximum speed of at least 200 mm/s, as measured in a Rheotens apparatus using a capillary die with a diameter of 2 mm and a length of 6 mm and a temperature of 200° C. with an acceleration of the melt strand drawn down of 120 mm/sec², and a melting temperature Tm of at least 135° C., preferably at least 140° C. more preferably at least 145 and most preferably at least 150° C.,
b. subjecting the HMS-PP foam to a thermal treatment at a temperature Tt which is between 5 and 40° C., preferably between 5 and 30° C., more preferably between 5 and 20° C. below the melting temperature Tm of the HMS-PP for a duration between 1 min and 2 hours.

The inventors have found that the process according to the invention it is possible to obtain a foam having very low organic compounds emissions. The specified polypropylene foam allows for a heat treatment at high temperatures where the organic volatiles have sufficient vapor pressure to vaporize in short time during the heat treatment and where the product nevertheless is dimensionally stable. In this process not only the VOC but also the FOG is reduced.

### BRIEF DESCRIPTION OF DRAWINGS

FIG. 1 shows the effect of heat treatment temperature at 3 min treatment time

FIG. 2 shows the effect of heat treatment time at 140° C. treatment temperature.

The figures are meant for illustrative purposes only, and do not serve as restriction of the scope or the protection as laid down by the claims.

### DETAILED DESCRIPTION OF THE INVENTION

Preferably, the thermal treatment is done at a treatment temperature Tt between 5 and 15° C. lower than the melting temperature of the HMS-PP and for a duration between 1 and 10 minutes, preferably between 2 and 8 or 3 to 5 minutes. More preferably, the melting temperature Tm of the HMS-PP foam is at least 150° C. and the thermal treatment temperature Tt is between 120 and 145° C. At the higher Tm the dimension stability is guaranteed at higher temperatures and volatiles can be reduced in shorter time at higher temperature.

The melting temperature Tm is measured according to ISO-11357-3 by DSC analysis using a TA Instrument Q2000 differential scanning calorimetry device (DSC) on 5 to 10 mg samples. Crystallization (Tc) and melting temperatures (Tm) were obtained in a heat/cool/heat cycle with a scan rate of 10° C./min between 30° C. and 225° C. Melting (Tm) and crystallization (Tc) temperatures were taken as the peaks of the endotherms and exotherms in the cooling cycle and the second heating cycle respectively. In case the polypropylene composition comprises more than one polypropylene components, the melting temperature Tm refers to the melting temperature of the part of the composition that has the highest melting point; in particular in case of a heterophasic polypropylene composition the Tm refers to the (higher) Tm of the at least 50 wt % of polypropylene(s) forming the matrix.

The HMS-PP needs a high melt strength in view of the foaming process which typically has a melt strength of at least 25 cN at a maximum speed of at least 200 mm/s, yet more preferably by a melt strength of at least 25 cN at a maximum speed of at least 250 mm/s (measured in a Rheotens apparatus using a capillary die with a diameter of 2 mm and a length of 6 mm and a temperature of 200° C. with an acceleration of the melt strand drawn down of 120 mm/sec²) as defined in EP2000504, herein incorporated by reference.

Alternatively, the high melt strength of the HMS-PP polymer can be characterized in having a strain hardening factor (SHF), as described in U.S. Pat. No. 8,722,805 herein incorporated by reference, of at least 1.7, more preferably of at least 2, even more preferably in the range of 2 to 15, still more preferably in the range of 3.5 to 15, still even more preferably in the range of 3.5 to 6.5 measured at a strain rate of 3.0 s−1 and a Hencky strain of 2.5.

The HMS-PP preferably has a melt flow rate MFR of between 0.5 and 7 and most preferably between 0.5 and 4 dg/min according to ASTM 01238 Condition L. Preferably the HMS-PP has a z-average molecular weight of at least 2000000 g/mol as measured by known procedures, preferably by GPC/VIS/LS.

The propylene composition used in the process comprises a high melt strength propylene (HMS-PP) homopolymer or copolymer or combinations thereof. Combinations can be physical blends, mixtures or reactor blends. For the purpose of the present invention, the expression “propylene homopolymer” refers to a polypropylene that consists substantially, i.e. of at least 97 mol.-%, preferably of at least 98 mol.-%, more preferably of at least 99 mol.- %, most preferably of at least 99.8 mol.-% of propylene units. In a preferred embodiment only propylene units in the propylene homopolymer are detectable.

A propylene copolymer preferably comprises propylene monomers and 1.0 to 10.0 wt % of at least one comonomer selected from ethylene and a C4-C12 alpha olefin. A preferred PP copolymer is a crystalline propylene random copolymer comprising propylene monomers and having a melting temperature in the range of 135 to 155° C. as measured according to ISO-11357-3 and a melt flow rate (MFR2) in the range of 0.1 to 15 g/10 min as measured according to ISO 1133 at a temperature of 230° C. and under a load of 2.16 kg.

The high melt strength polypropylene HMS-PP can be I) a long-chain branched polypropylene synthesized with a metallocene catalyst or II) produced by modifying polypropylene homopolymer or polypropylene copolymer having less than 6 wt % of comonomer wherein the modification is done a) by e-beam irradiation or b) by reacting with peroxides in the presence of a polyunsaturated compound followed by thermal treatment to reduce volatiles to a VOC below 75 μgTE/g and a FOG below 150 μgHD/g.

Suitable HMS branched polypropylene can be obtained by the use of a specific metallocene catalyst as described in EP1892264, which is incorporated herein by reference.

EP0879830, which is incorporated herein by reference, describes a suitable high melt strength (HMS) polypropylene produced in a post-reactor process (process II.b above) wherein polypropylene homopolymer or polypropylene copolymer are modified with peroxide and butadiene. This patent covers a wide range of powder melt flow rates (MFR's) and particle sizes. In such process a thermal post treatment is preferably done to reduce emissions from degradation product and possible unreacted reactants from the HMS-PP polymer itself.

Another suitable HMS-PP is described in U.S. Pat. No. 6,521,675, which is incorporated herein by reference, and which relates to a foamable polypropylene composition comprising a polypropylene resin having a melt flow rate of from about 0.5 to about 30 g/10 min and a method for extruding rigid, foamed polypropylene sheet with improved surface appearance having a density in the range 0.4 to about 0.8 g/cm³. The polypropylene resin has monomodal molecular weight distribution and an absence of significant branching

Suitable commercially available HMS-PP grades are for example Daploy WB140HMS, WB135HMS or WB130HMS from Borealis AG, Austria.

In a preferred embodiment the propylene polymer composition used in the process comprises at least 50 wt % (relative to the total weight of the propylene polymer composition) of a) the HMS-PP and up to 50 wt % of b) one or more polypropylene copolymers like random copolymers or heterophasic copolymers with ethylene and optionally other C4-C10 alpha-olefins or polyethylene. This propylene polymer composition may be a heterophasic copolymer composition wherein the HMS-PP polymer a) forms the matrix phase together with the random copolymer b) or the matrix part of the heterophasic copolymer b), while the disperse rubber phase of the heterophasic copolymer b) and/or polyethylene forms the disperse phase. The melting temperature Tm of such a propylene polymer composition is the Tm of the component(s) forming the matrix phase, and in case there are more than one melting temperatures it implies the lowest melting temperature of the matrix phase.

EP1354901, which is incorporated herein by reference, describes a suitable heterophasic propylene polymer composition comprising a matrix phase comprising a propylene homopolymer and/or a propylene copolymer with up to 20 wt % of ethylene, which can be a HMS-PP, and a disperse phase comprising an ethylene rubber copolymer with propene and from 20 to 70 wt % of ethylene, the ethylene rubber copolymer being distributed within the polymer composition in the form of particles.

In a preferred embodiment, the polypropylene composition to be used in the process comprises HMS-PP in mixture with a heterophasic polypropylene copolymer (HECO), for example BC250MO from Borealis, preferably in relative amounts between 30-70, preferably 40-60 wt % HMS-PP (wt % on total of HMS-PP and HECO). Typical heterophasic polypropylene copolymers (HECOs) comprise a polypropylene homopolymer as matrix phase and are characterized by a melting temperature Tm in the range of 150 to 170° C. Such copolymers are for example described in WO 2016/066446 and EP 3015504.

Such heterophasic propylene copolymers (HECOs) comprise a matrix being either a propylene homopolymer or a random propylene copolymer in which an amorphous phase, which contains a propylene copolymer rubber (elastomer), is dispersed. Thus the polypropylene matrix contains (finely) dispersed inclusions not being part of the matrix and said inclusions contain the elastomer. The term inclusion indicates that the matrix and the inclusion form different phases within the heterophasic propylene copolymer (HECO), said inclusions are for instance visible by high resolution microscopy, like electron microscopy or scanning force microscopy or atomic force microscopy, or by dynamic mechanical thermal analysis (DMTA). Further the heterophasic polypropylene may contain to some extent a crystalline polyethylene, which is a by-reaction product obtained by the preparation of the heterophasic propylene copolymer. Such crystalline polyethylene is present as inclusion of the amorphous phase due to thermodynamic reasons.

The polypropylene composition to be used in the process may comprise a minor amount of non-propylenic polymers, which may include high-, medium-, low-, and linear-density polyethylenes, polybutene-1, ethylene/acrylic acid copolymer, ethylene/vinyl acetate copolymer, ethylene/propylene copolymer, styrene/butadiene copolymer, ethylene/styrene copolymer, ethylene/ethyl acrylate copolymer, and ionomer. The foamable propylene polymer composition may, if desired, contain other useful thermoplastics such as high density polyethylene, chlorinated polyethylene, thermoplastic olefin mixtures of EPDM rubbers (ethylene/propylene/diamine copolymers) and polyethylene. The foamable propylene polymer composition preferably comprises less than 20 wt %, more preferably less than 10 and most preferably less than 5 wt % non-propylenic polymer based upon the total weight of the propylene polymer composition.

The foam may be produced by vacuum foaming, by physical agitation of the foamable propylene composition mixture or by incorporating a blowing agent into the foamable propylene polymer composition. In a preferred embodiment a blowing agent is incorporated into the foamable propylene polymer composition.

The foam product generally can be in the form of beads, typically having a foam density of 20 g/liter or higher or, more preferably in the form of extruded foam, typically having a foam density of 350 g/liter or lower. The foam can also be articles manufactured from the foam beads or extrudates.

The process can be a heat treatment on an existing foam product, but in a preferred embodiment of the process of the invention the foam is formed by extruding a composition comprising HMS-PP, a blowing agent and preferably a foam nucleating agent, then cooling the foamed extrudate to a temperature between 10 and 30° C. below the melt temperature Tm and subsequently bring the foamed extrudate to the thermal treatment temperature Tt and do the thermal treatment.

The blowing agent used in the foaming of the polypropylene composition invention is not limited to any class or type. It can be chemical blowing agents, or physical blowing agents of either hydrocarbon and/or inorganic types, combination of either types and/or both types or carbon dioxide. Preferably, however a physical blowing agent is used, preferably an aliphatic organic solvent having 3 to 10, preferably 3 to 8 carbon atoms, more preferably the polypropylene composition is extruded in the presence of an aliphatic organic solvent selected from n-butane, n-pentane, n-hexane, branched isomers or mixtures thereof.

The blowing agent is generally incorporated into the molten foamable propylene polymer composition to prepare the foamed layer. The amount of blowing agent incorporated into the molten foamable propylene composition is generally from 0.01 to 5, and preferably from 0.1 to 3 weight percent based on the total weight of blowing agent and foamable propylene polymer composition.

The blowing agent is partly dissolved in the polypropylene and as the blowing agent evaporates the effective melting temperature of the PP polymer increases and at the same time the extrudate is cooled by evaporation of the blowing taking. This leads to a quick fixing of the structure of the foam and shape of the product, which quickly provides dimension stability but also leads to volatile components entrapment. The heat treatment allows evaporation of the volatile blowing agent but also the evaporation of the blowing agent drives out the less volatile organic components resulting in a low VOC and low FOG.

The heat treatment process is carried out for a time and at a temperature such that the polypropylene foam product obtained has a volatile organic compounds (VOC) emission, determined according to VDA278:2011 at 90° C. for 0.5 hrs below 300 μgTE/g, preferably below 200, 150 or 100 and most preferably below 50 μgTE/g. Preferably, the polypropylene foam product obtained has a FOG emission, determined according to VDA278:2011 at 120° C. for 1.0 hrs, of below 200 μgHD/g, preferably below 150 and most preferably below 100 μgHD/g.

It has been found that the polypropylene foam product obtained can have a VOC and FOG emission level equal or less than 150%, 120% or more preferably less than 100% of the calculated weight average VOC and FOG emission level of the polypropylene constituents before foaming.

In the process the polypropylene composition preferably further comprises antioxidants and the heat treatment (temperature and time) is such that the amount of antioxidant reduces by less than 20 wt %, preferably less than 15 wt %, more preferably less than 10 wt %. This implies that in the process of the invention with the specific polypropylene there is no significant oxidative degradation during the heat treatment.

The foamable propylene polymer composition may optionally comprise a nucleating agent in order to control the size of foam cells. Useful nucleating agents are taught in U.S. Pat. No. 6,417,242 column 11 line 63 to column 12 line 3. Preferred nucleating agents include inorganic substances such as calcium carbonate, talc, clay, titanium dioxide, silica, barium stearate, and diatomaceous earth. The amount of nucleating agent employed may range from 0.1 to 3 parts by weight per hundred parts by weight of a polymer resin. The preferred range is from 0.3 to 2 parts by weight.

Further additives are optionally included in the foamable propylene polymer composition, such as stabilizers including free radical inhibitors and ultraviolet wave (UV) stabilizers, neutralizers, slip agents, anti-block agents, pigments, antistatic agents, clarifiers, waxes, resins, fillers such as nano-fillers, silica and carbon black, foam stabilizers and other additives within the skill in the art which are used in combination or alone. Effective amounts are known in the art and depend on parameters of the polymers in the composition and conditions to which they are exposed.

The PP composition comprising the HMS-PP and comprising blowing agents and optionally nucleating agents and other additives and optionally other polymers as described above is extruded from the melt from a cylindrical die. The foaming starts on exit of the melt from the die. The cylindrical foam sheet cools is slit open to form sheets. Orientation or stretching may take place after extrusion.

The invention also relates to a polypropylene foam product obtainable by the process according to the invention, preferably in the form of foamed sheet, beads, pipes, preferably sheets or articles made from foamed sheets or beads. The polypropylene foam product has low VOC and preferably also a low FOG properties as described above.

The invention also relates to a process for the manufacture of articles comprising a foam and having a low VOC and low FOG for use in closed rooms or compartments, in particular in cars or in food packaging, said process comprising the use of a polypropylene foam produced according to the process of the invention.

### EXAMPLES

The examples are intended to be illustrative, not limiting. It will be apparent to the person skilled in the art that alternative and equivalent embodiments of the invention can be conceived and reduced to practice, without departing from the scope of the invention.

### Example 1

A polypropylene composition comprising 50 wt % WB140HMS (from Borealis), 49 wt % BC250MO (from Borealis), 1 wt % talc as foam nucleator was extruded using 4 wt % isobutene as the blowing agent to make a foam sheet having a density of 150 g/liter. BC250MO is a high impact polypropylene heterophasic copolymer. The 3 mm foam layer was directly cooled to room temperature. The melting temperature Tm of the foam sheet was 150° C. (measured by DSC, 10° C. per minute, measured 1 hour after sheet production).

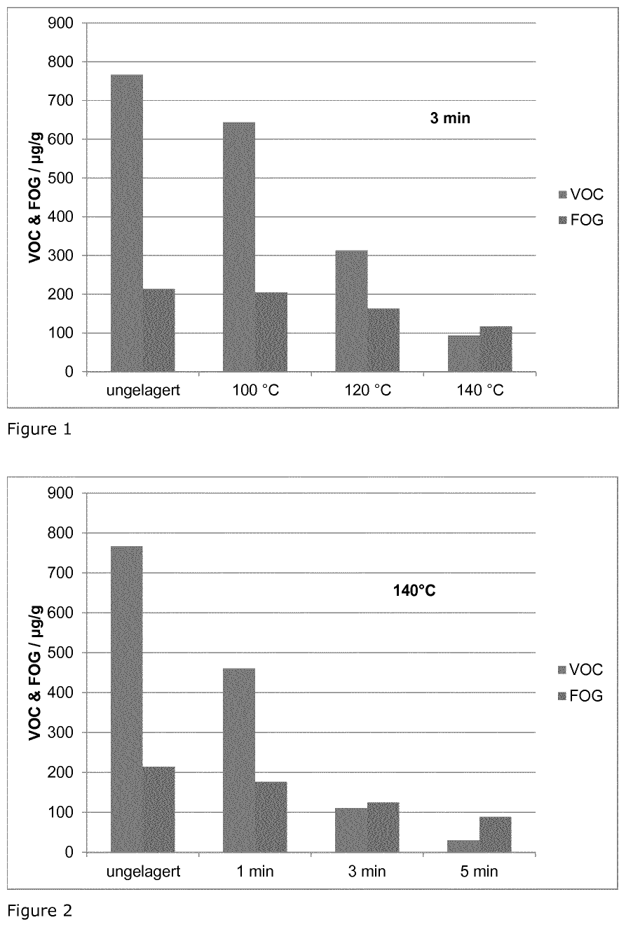

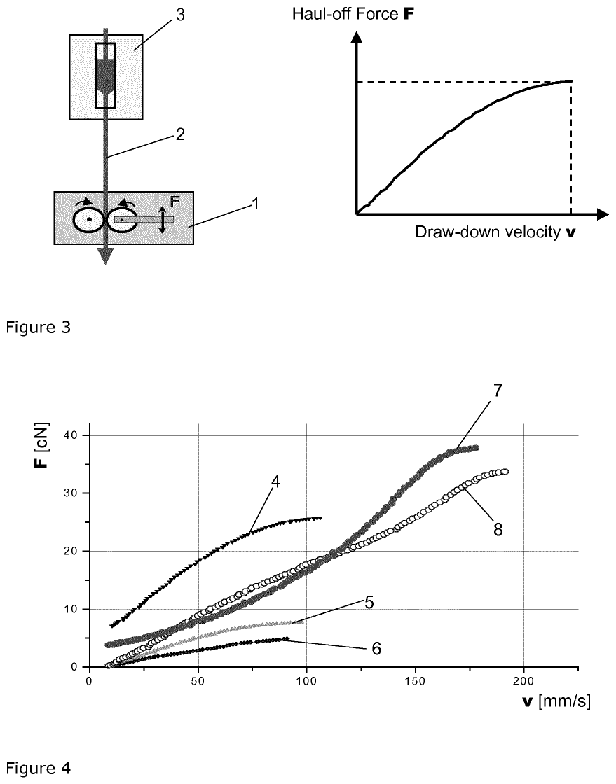

The extrusion-foamed sheet was cut into pieces of 10×10 cm and subjected to heat treatment for periods ranging between 1 minute and 4 days at temperatures of 100° C., 120° C. and 140° C. The VOC and FOG values of the samples have been measured as described below. The results are presented in FIGS. 1 and 2.

### VOC

VOC emissions have been determined according to VDA 278:2011. VDA standards are issued by “Verband der Automobilindustrie”. The VDA 278 standard specifies a strict workflow. Here, two calibration standards are measured. Toluene is used to determine the response factor for the VOC calibration and hexadecane respectively for determination of the response factor for the FOG calibration. After injection of the standard solution, the solvent is evaporated for five minutes under a continuous flow of nitrogen (100 mL/min). The sample to be investigated (upper layer of fairing parts) is removed from its packaging immediately prior to analysis and cut into small pieces (approx. 10 mg) which are then placed in the middle of a carefully cleaned desorption tube. Each sample is measured twice—first to determine its VOC value (desorption at 90° C., for 30 minutes) and subsequently also to determine its FOG value (desorption at 120° C., for 1 hour).

VOC according to VDA 278 is the sum of all high and medium volatile compounds. It is calculated as toluene equivalent (TE). VOC according to VDA 278 represents all organic compounds in the boiling point and elution range of up to C20 (n-eicosane). VOC=130 μgTE/g and FOG=384 μgHD/g (excluding blowing agent and degradation)

VOC and FOG emissions have been determined from a HMS-PP sheet of 10×10 cm.

### FOG

FOG was determined according to VDA 278:2011. FOG according to VDA 278 is the sum of all organic compounds of low volatility, which have an elution time greater than or equal to n-hexadecane. FOG is calculated as hexadecane equivalent (HE). FOG according to VDA 278 represents organic compounds in the boiling point range of n-alkanes C16 to C32.

Also the VOC and FOG of the constituent polypropylene starting materials WB140HMS and BC250MO were measured. The values were WB140HMS: VOC=67 μgTE/g and FOG=102 μgHD/g BC250MO: VOC=196 μgTE/g and FOG=680 μgHD/g The weight average calculated values for the polypropylene composition before foaming (hence excluding blowing agent and degradation) would be: VOC=130 μgTE/g and FOG=384 μgHD/g.

The results show that a very quick reduction of VOC and FOG was possible in particular at the highest tested temperature of 140° C. Further it has been shown that the VOC/FOG emissions of the foam according to the invention are even lower than the calculated average value for the starting materials and even lower than the values of the HMS-PP component itself.

### Strain Hardening Behaviour (Melt Strength)

The strain hardening behaviour is determined by the method as described in EP2000504, herein incorporated by reference, and also in the article “Rheotens-Mastercurves and Drawability of Polymer Melts”, M. H. Wagner, Polymer Engineering and Sience, MID-APRIL ISW, Vol. 36, NO. 7, pages 925 to 935. The content of the document is included by reference.

For detailed explanation of the measuring method it is also referred to the FIGS. 3 and 4. FIG. 3 shows a schematic representation of the experimental procedure which is used to determine strain hardening.

The strain hardening behaviour of polymers is analyzed by Rheotens apparatus (1) (product of Göttfert, Siemensstr.2, 74711 Buchen, Germany) in which a melt strand (2) is elongated by drawing down with a defined acceleration. The haul-off force F in dependence of draw-down velocity v is recorded.

The test procedure is performed in a standard climatized room with controlled room temperature of 23° C. The Rheotens apparatus (1) is combined with an extruder/melt pump (3) for continuous feeding of the melt strand (2). The extrusion temperature is 200° C.; a capillary die with a diameter of 2 mm and a length of 6 mm is used. At the beginning of the experiment, the take-up speed of the Rheotens wheels was adjusted to the velocity of the extruded polymer strand (tensile force zero): Then the experiment was started by slowly increasing the take-up speed of the Rheotens wheels until the polymer filament breaks. The acceleration of the wheels was small enough so that the tensile force was measured under quasi-steady conditions. The acceleration of the melt strand (2) drawn down is 120 mm/sec².

The Rheotens was operated in combination with the PC program EXTENS. This is a real-time data-acquisition program, which displays and stores the measured data of tensile force and drawdown speed.

The schematic diagram in FIG. 1 shows in an exemplary fashion the measured increase in haul-off force F (i.e. “melt strength”) versus the increase in draw-down velocity v (i.e. “drawability”).

FIG. 4 shows the recorded curves of Rheotens measurements of polymer samples with and without strain hardening behaviour. The maximum points (Fmax; vmax) at failure of the strand are characteristic for the strength and the drawability of the melt.

The standard propylene polymers 4,5,6 with melt indices of 0.3, 2.0 and 3.0 g/10 min at 230° C./2.16 kg show a very low melt strength and low drawability. They have no strain hardening.

Modified propylene polymer 7 (melt index of sample in diagram is 2 to 3 g/10 min at 230° C./2.16 kg) or LDPE 8 (melt index of sample in diagram is 0.7 g/10 min at 230° C./2.16 kg) show a completely different drawability versus melt strength behaviour. With increasing the draw down velocity v the haul-off force F increases to a much higher level, compared to the standard propylene polymers 4,5,6. This curve shape is characteristic for strain hardening.

### Strain Hardening Factor (SHF)

The strain hardening factor has been measured as described in U.S. Pat. No. 8,722,805, which is incorporated herein by reference. The strain hardening factor is defined as

$$SHF = \frac{{η}_{E}^{+} ( t , ɛ )}{{η}_{LVE}^{+} ( t )} = \frac{{η}_{E}^{+} ( t , ɛ )}{3 {η}^{+} ( t )}$$

wherein
η_{E}⁺(t,\dot{ε}) is the uniaxial extensional viscosity; and
η_{LVE}⁺(t) is three times the time dependent shear viscosity (η⁺ (t)) in the linear range of deformation.

The determination of the linear viscoelastic envelop in extension (η_{LVE}⁺(t)), using IRIS Rheo Hub 2008, required the calculation of the discrete relaxation time spectrum from the storage and loss modulus data (G′, G″ (ω)). The linear viscoelastic data (G′, G″ (ω)) was obtained by frequency sweep measurements undertaken at 180° C., on a Anton Paar MCR 300 coupled with 25 mm parallel plates. The underlying calculation principles used for the determination of the discrete relaxation spectrum are described in Baumgartel M, Winter H H, “Determination of the discrete relaxation and retardation time spectra from dynamic mechanical data”, Rheol Acta 28:511519 (1989) which is incorporated by reference in its entirety. IRIS RheoHub 2008 expresses the relaxation time spectrum as a sum of N Maxwell modes

$${G}^{o} ( t ) = {G}_{e} \cdot {\sum }_{1}^{N} {g}_{i} \cdot {e}^{- \frac{t}{{λ}_{i}}}$$

wherein gᵢ and λᵢ are material parameters and Gₑ is the equilibrium modulus.

The choice for the maximum number of modes, N used for determination of the discrete relaxation spectrum, is done by using the option “optimum” from IRIS RheoHub 2008. The equilibrium modulus Gₑ was set at zero. The non-linear fitting used to obtain η_{LIVE}⁺(t) is performed on IRIS Rheo Hub 2008, using the Doi-Edwards model.

The uniaxial extensional viscosity η_{E}⁺(t,\dot{ε}) is obtained from uniaxial extensional flow measurements, conducted on an Anton Paar MCR 501 coupled with the Sentmanat extensional fixture (SER-1). The temperature for the uniaxial extensional flow measurements was set at 180° C., applying extension (strain) rates ∂ε/∂t ranging from 0.3 s⁻¹ to 10 s⁻¹ and covering a range of Hencky strain

ε=In[(I−I₀)/I₀],

with I₀ being the original and I the actual sample fixation length, from 0.3 to 3.0. Particularly care was taken for the preparation of the samples for extensional flow. The samples were prepared by compression moulding at 230° C. followed by slow cooling to room temperature (forced water or air cooling were not used). This procedure allowed obtaining well shaped samples free of residual stresses. The sample was left for five minutes at the testing temperature to ensure thermal stability (set temperature ±0.1° C.), before carrying out the uniaxial extensional flow measurements.

1. A process for production of a foam having low organic compounds emissions, the process comprising the steps of:
a) providing a foam comprising a propylene composition comprising a high melt strength propylene (HMS-PP) homopolymer or copolymer or combinations thereof, said HMS-PP foam having a melt strength of at least 25 cN at a maximum speed of at least 200 mm/s, as measured in a Rheotens apparatus using a capillary die with a diameter of 2 mm and a length of 6 mm and a temperature of 200° C. with an acceleration of the melt strand drawn down of 120 mm/sec², and a melting temperature of at least 135° C. measured according to ISO-11357-3 by DSC analysis,
b) subjecting the HMS-PP foam to a thermal treatment at a temperature Tt which is between 5 and 40° C. below the melting temperature Tm of the HMS-PP for a duration between 1 min and 2 hours.

2. The process of claim 1 wherein the thermal treatment is done at a treatment temperature Tt between 5 and 15° C. lower than the melting temperature of the HMS-PP and for a duration between 1 and 10 minutes.

3. The process of claim 1 wherein the melting temperature Tm of the HMS-PP foam is at least 150° C. and the temperature Tt is between 120 and 145° C.

4. The process of claim 1 wherein the HMS-PP has a melt strength as characterized by the strain hardening factor (SHF), measured as described in the description, of at least 1.7 measured at a strain rate of 3.0 s−1 and a Hencky strain of 2.5.

5. The process of claim 1 wherein the foam is formed by extruding a composition comprising HMS-PP a blowing agent and a foam nucleating agent, then cooling the foamed extrudate to a temperature between 10 and 30° C. below the melting temperature Tm of the HMS-PP and subsequently bringing the foamed extrudate to the temperature Tt and doing the thermal treatment.

6. The process of claim 1 wherein the HMS-PP is I) a long-chain branched polypropylenes synthesized with a metallocene catalyst or II) produced by modifying polypropylene homopolymer or polypropylene copolymer having less than 6 wt % of comonomer wherein the modification is done a) by e-beam irradiation or b) by reacting with peroxides in the presence of a polyunsaturated compound followed by thermal treatment to reduce volatiles to a VOC below 75 μgTE/g, as determined according to VDA 278:2011, and a FOG below 150 μgHD/g, as determined according to VDA 278:2011.

7. The process of claim 1 wherein the foam is in the form of extruded foam having a foam density of 350 g/liter or lower.

8. The process according to claim 1 wherein the propylene polymer composition comprises at least 50 wt % relative to the total weight of the propylene polymer composition of a) the HMS-PP and up to 50 wt % of b) one or more polypropylene random copolymers or heterophasic copolymers with ethylene and optionally other C4-C10 alpha-olefins, or polyethylene.

9. The process according to claim 8, wherein the propylene polymer composition is a heterophasic copolymer composition wherein the HMS-PP polymer a) forms the matrix phase together with the random copolymer b) and/or the matrix of the heterophasic copolymer b) while the dispersed phase of the heterophasic copolymer b) forms the dispersed phase of the heterophasic copolymer composition.

10. The process according to claim 1, wherein the polypropylene foam product obtained has a volatile organic compounds (VOC) emission, determined according to VDA278:2011 at 90° C. for 0.5 hrs below 300 μgTE/g.

11. The process according to claim 1, wherein the polypropylene foam product obtained has a FOG emission, determined according to VDA278:2011 at 120° C. for 1.0 hrs, of below 200 μgHD/g.

12. The process according to claim 1, wherein the polypropylene foam product obtained has a VOC and FOG emission level equal or less than 150% of the calculated weight average VOC and FOG emission level of the polypropylene constituents before foaming.

13. The process of claims 1, wherein the polypropylene composition further comprises antioxidants and wherein the heat treatment is such that the amount of antioxidant reduces by less than 20 wt %.

14. A polypropylene foam product obtainable by the process of claims 1, in the form of foamed sheet, beads, pipes, or articles made from foamed sheets or beads.

15. A process comprising manufacturing articles with the polypropylene foam of claim 1, wherein the articles comprise a foam, and the articles having a low VOC and low FOG.

16. The process according to claim 1, wherein said HMS-PP foam has a melting temperature of at least 140° C., and wherein step b) comprises subjecting the HMS-PP foam to thermal treatment at a temperature Tt which is between 5 and 30° C.

17. The process according to claim 2 wherein the thermal treatment is done for a duration between 2 and 8 minutes.

18. The process according to claim 4 wherein the HMS-PP has a melt strength as characterized by the SHF in the range of 2 to 15.

19. The process according to claim 10, wherein the polypropylene foam product obtained has a volatile organic compounds (VOC) emission below 150 μgTE/g.

20. The process according to claim 11, wherein the polypropylene foam product obtained has a FOG emission below 150 μgHD/g.
